(19) United States
(12) Patent Application Publication
(10) Pub. No.: US 2012/0248726 A1
(43) Pub. Date: Oct. 4, 2012

(54) VEHICULAR AXLE ASSEMBLY INCLUDING A CLAMPING SUPPORT FOR AN AXLE

(76) Inventors: SCOTT DANIEL BATDORF, Raymond, OH (US); Daniel Thomas Sellars, West Liberty, OH (US)

(21) Appl. No.: 13/077,064

(22) Filed: Mar. 31, 2011

(51) Int. Cl. B60G 9/02

(52) U.S. Cl. 280/124.117

(57) ABSTRACT

A vehicular axle assembly includes a swing member, a housing support, an axle, a stabilizing assembly, and left and right bearings. The swing member is configured for pivotal attachment to a frame of a vehicle. The housing support is coupled with the swing member. The axle is rotatably coupled with the housing support. The stabilizing assembly is coupled with the housing support and includes left and right clamping supports. The left and right clamping supports define respective right and left passageways. The left bearing is at least partially disposed within the left passageway and is clamped within the left passageway by the left clamping support. The right bearing is at least partially disposed within the right passageway and is clamped within the right passageway by the right clamping support. The left and right hearings journal the axle with respect to the left and right clamping supports, respectively.

### TECHNICAL FIELD

A vehicular axle assembly can include left and right clamping supports that are configured to selectively clamp respective left and right axle bearings. The left and right axle bearings can journal an axle with respect to the left and right clamping supports.

### BACKGROUND

An axle of a vehicle can be rotatably supported with respect to a swing member by a pair of left and right bearings.

### SUMMARY

in accordance with one embodiment, a vehicular axle assembly comprises a swing member, a housing support, an axle, a stabilizing assembly, a left bearing, and a right bearing. The swing member is configured for pivotal attachment to a frame of a vehicle. The housing support is coupled with the swing member. The axle is rotatably coupled with the housing support and is rotatable about a first axis. The stabilizing assembly is coupled with the housing support and comprises a left clamping support and a right clamping support. The left clamping support defines a left passageway and the right clamping support defines a right passageway. The left bearing is at least partially disposed within the left passageway and is clamped within the left passageway by the left clamping support. The right bearing is at least partially disposed within the right passageway and is clamped within the right passageway by the right clamping support. The left bearing and the right bearing journal the axle with respect to the left and right clamping supports, respectively.

In accordance with another embodiment, a vehicle comprises a frame, a swing member, a housing support, an axle, a stabilizing assembly, a left bearing, and a right bearing. The swing member is attached to the frame. The housing support is coupled with the swing member. The axle is rotatably coupled with the housing support and is rotatable about a first axis. The stabilizing assembly is coupled with the housing support and comprises a left clamping support and a right clamping support. The left clamping support defines a left passageway and the right clamping support defines a right passageway. The left bearing is at least partially disposed within the left passageway and is clamped within the left passageway by the left clamping support. The right bearing is at least partially disposed within the right passageway and is clamped within the right passageway by the right clamping support. The left bearing and the right bearing journal the axle with respect to the left and right clamping supports, respectively.

In accordance with yet another embodiment, a vehicle comprises a frame, a swing member, a housing support, an axle, a stabilizing assembly, a left bearing, a first bolt, a right bearing, and a second bolt. The swing member is attached to the frame. The housing support is coupled with the swing member. The axle is rotatably coupled with the housing support and is rotatable about a first axis. The stabilizing assembly is coupled with the housing support and comprises a central portion, a left clamping support, and aright clamping support. The central portion is coupled with the housing support. The left clamping support is coupled with central portion and comprises a left split cuff, a left upper clamping flange, and a left lower clamping flange. The left split cuff defines a left passageway. The left upper clamping flange defines a non-threaded passageway. The left lower clamping flange defines a threaded passageway. The right clamping support is coupled with central portion and comprises a right split cuff, a right upper clamping flange, and a right lower clamping flange. The right split cuff defines a right passageway. The right upper clamping flange defines a non-threaded passageway. The right lower clamping flange defines a threaded passageway. The left bearing is at least partially disposed within the left passageway. The first bolt extends through the non-threaded passageway of the left upper clamping flange and into the threaded passageway of the left lower clamping flange. The right bearing is at least partially disposed within the right passageway. The second bolt extends through the non-threaded passageway of the right upper clamping flange and into the threaded passageway of the right lower clamping flange. The left bearing and the right bearing journal the axle with respect to the Jell and right clamping supports, respectively.

### BRIEF DESCRIPTION OF THE DRAWINGS

Various embodiments will become better understood with regard to the following description, appended claims, and accompanying drawings wherein:

FIG. 1 is a rear elevational view depicting a vehicle in accordance with one embodiment;

FIG. 2 is an enlarged rear perspective view depicting an axle assembly together with other components of the vehicle of FIG. 1;

FIG. 3 is a rear elevational view depicting the axle assembly together with the other components of FIG. 2;

FIG. 4 is an exploded perspective view depicting a left clamping support of the axle assembly of FIG. 2 together with other components, according to one embodiment;

FIG. 5 is an assembled perspective view depicting the left clamping support and other components of FIG. 4; and

FIG. 6 is a cross-section view depicting the left clamping support take along the section line 6-6 in FIG. 5 with certain components removed for clarity of illustration.

### DETAILED DESCRIPTION

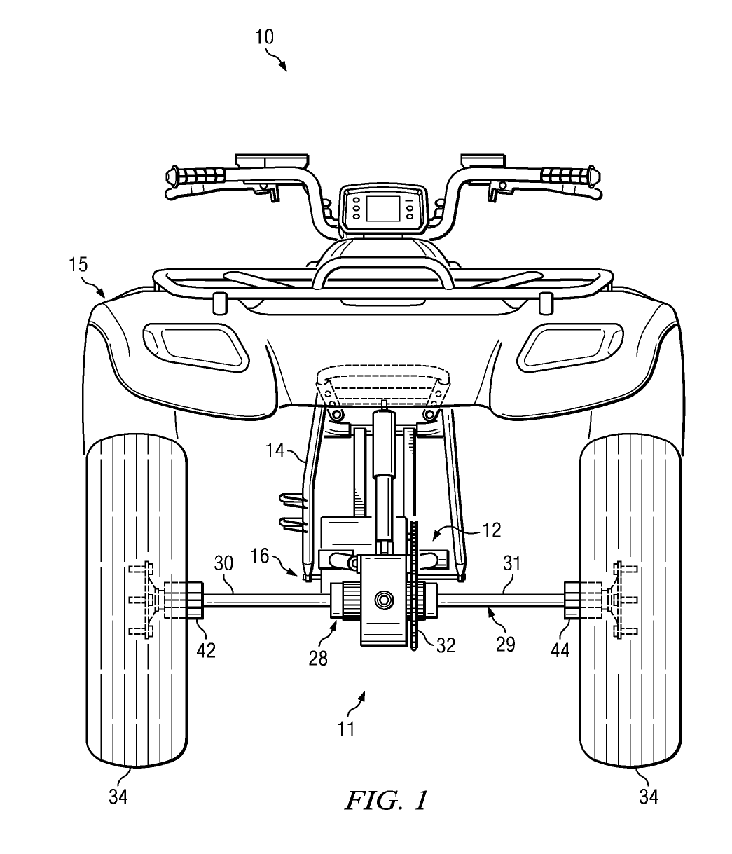

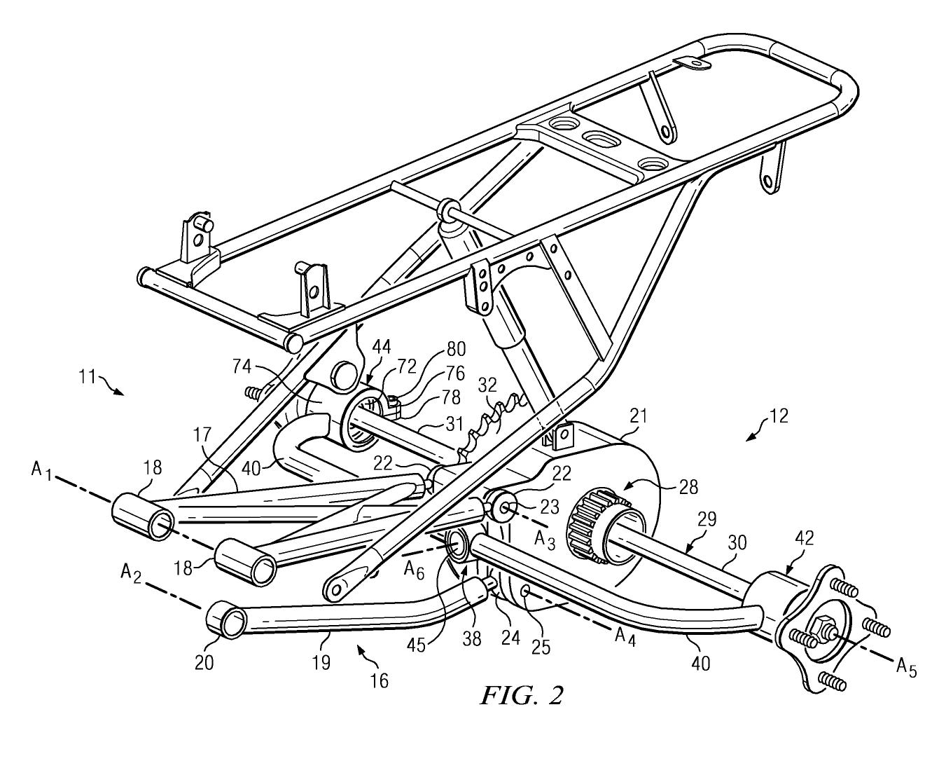

The present invention and its operation are hereinafter described in detail in connection with the views and examples of FIGS. 1-6, wherein like numbers indicate the same or corresponding elements throughout the views. A suspension assembly in accordance with one embodiment of the present invention can be provided upon a vehicle 10. The vehicle 10 is shown in FIG. 1 to comprise an ATV, but in other embodiments, the vehicle 10 can include an automobile, a recreational vehicle, or a utility vehicle, for example. In one embodiment, and as depicted in FIGS. 1 and 2, an axle assembly 11 can comprise a swing arm assembly 12 that is movably attached to a frame 14. In one embodiment, the frame 14 can have a plurality of tubular frame components. However, the frame 14 can be provided in any of a variety of suitable alternative arrangements, such as formed integrally with a vehicular unibody. The frame 14 can support a body 15 which in some embodiments can include a variety of decorative panels.

The swing arm assembly 12 can include a swing member assembly 16. In one embodiment, as illustrated in FIG. 2, the swing member assembly 16 can include an upper swing member 17, a lower swing member 19, and a housing support 21. The upper swing member 17 can include upper front supports 18 and upper rear supports 22. In one embodiment, the upper front supports 18 and upper rear supports 22 can include cylindrical portions. A pin (not shown) can be provided through the frame 14 and the upper front supports 18 to facilitate pivoting of the upper swing member 17 on the pin and about an axis A1. Another pin (e.g., 23) can he provided through the housing support 21 and the upper rear supports 22 to facilitate pivoting of the upper swing member 17 about an axis A3 with respect to the housing support portion 21.

In such an embodiment, as further illustrated in FIG. 2, the lower swing member 19 can include a lower front support 20 and a lower rear support 24. Similar to the upper front and rear supports 18, 22 of the upper swing member 17, the lower front support 20 and the lower rear support 24 can include cylindrical portions. A pin (not shown) can be provided through the frame 14 and the lower front support 20 to facilitate pivoting of the lower swing member portion 19 about an axis A2 with respect to the frame 14. Likewise, another pin (e.g., 25) can be provided through the housing support portion 21 and the lower rear support 24 to facilitate pivoting of the lower swing member 19 about an axis A4 with respect to the housing support portion 21. The upper and lower swing members 17, 19 can accordingly facilitate vertical movement of the housing support portion 21 with respect to the frame 14. It will be appreciated that supports of a swing member can cooperate with the frame in any variety of alternative mechanical engagements such as might involve one or more spherical joints, rubber bushings, heim joints, saddle joints, or the like.

It will also be appreciated that a swing member assembly can he provided in any of a variety of other suitable configurations. For example, a swing member assembly can include only a single (e.g., upper) swing member which is movably attached to a vehicle's frame. This single swing member can be integrally provided with or fixedly attached to a housing support portion such that the swing member and the housing support portion pivot together with respect to the vehicle's frame. Such an arrangement might not include any other (e.g., lower) swing members for attaching a housing support portion to the vehicle's frame. As another example, a swing member assembly might include more than two swing members.

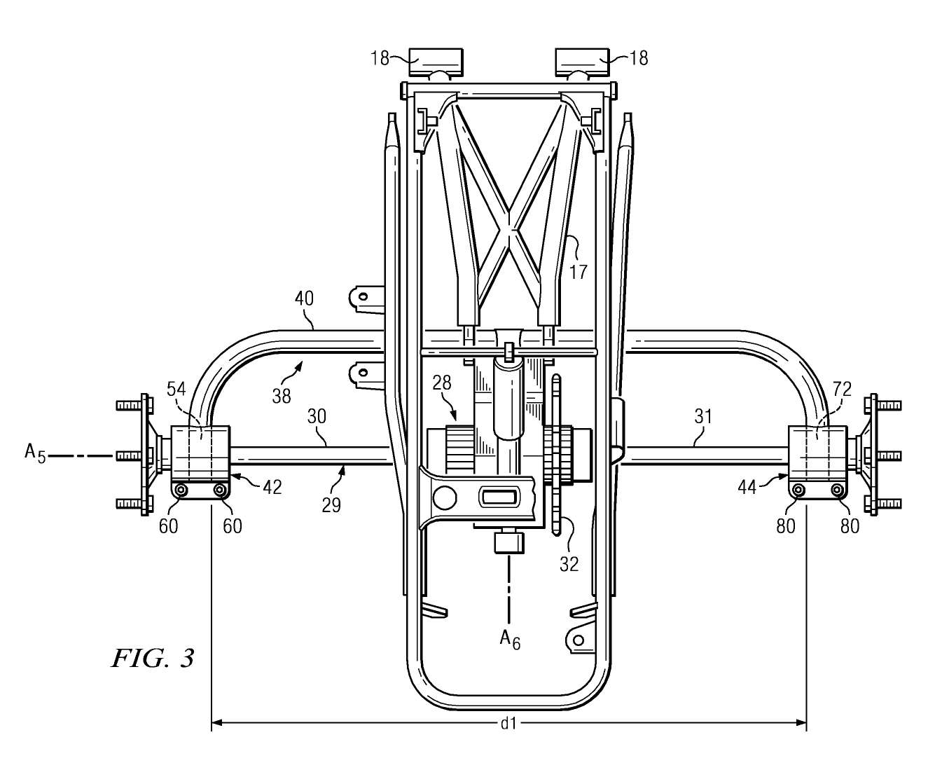

As illustrated in FIGS. 1-3, a housing 28 can be rotatably coupled with the housing support 21 using any variety of rotational arrangements such as bearings, frictional engagement using viscous fluid, magnetic levitation, or the like. The housing 28 can support a rear axle 29 such that rotation of the housing 28 facilitates rotation of the rear axle 29 about an axis A5 (FIGS. 2 and 3). As illustrated in FIGS. 1-3, the rear axle 29 can comprise a tell shall 30 and a right shaft 31. In one embodiment, the rear axle 29 can be a single, continuous axle shaft (e.g., formed as a one-piece construction) with the left and right shafts 30, 31 integrally coupled together. In another embodiment, the left and right axle shafts 30, 31 can be separate from each other (e.g., half shafts). The housing 28 can be coupled (e.g., directly or indirectly) with the rear axle 29 through any of a variety of suitable arrangements. For example, the housing 28 can be directly coupled with the rear axle 29 through a splined arrangement. In another example, a constant velocity joint can couple the housing 28 with the rear axle 29.

As illustrated in FIGS. 1-3, a driven sprocket 32 can be coupled with the housing 28. A flexible transmitter, such as a chain or a cogged belt (not shown), can couple the driven sprocket 32 to an engine's driveshaft. The driveshaft can accordingly rotate the driven sprocket 32 to rotate the rear axle 29 to drive rear wheels (e.g., 34 shown in FIG. 1). In one embodiment, the driven sprocket 32 can be directly splined onto the housing 28. In another embodiment, in lieu of the driven sprocket 32, a pulley can be coupled with the housing 28 and selectively driven with the engine's driveshaft by a V-belt. In yet another embodiment, a gear arrangement, such as a worm gear arrangement, for example, can be coupled with the housing 28 and driven by the engine's driveshaft to rotate the housing 28. It will be appreciated that the housing 28 can be driven, directly or indirectly, by the driveshaft of the vehicle 10 in any of a variety of suitable alternative arrangements.

It will also be appreciated that the housing 28 can additionally or alternatively be coupled with a brake disc (not shown). In one embodiment, the brake disc can be coupled with the housing 28 thorough splined engagement similar to that described with respect to the driven sprocket 32. The brake disc can be associated with a caliper which can be selectively actuated (e.g., through operation of a brake lever or a brake pedal) to inhibit rotation of the housing 28.

The axle assembly 11 can further comprise a stabilizing assembly 38 as shown in FIGS. 2-3, for example. The stabilizing assembly 38 can comprise a central portion 40, a left clamping support 42, and a right clamping support 44. The left clamping support 42 and the right clamping support 44 can be respectively coupled with opposing ends of the central portion 40 and can cooperate to rotatably support the rear axle 29. In one embodiment as illustrated in FIG. 2, the stabilizing assembly 38 can be pivotally coupled with the housing support 21 such that the stabilizing assembly 38 pivots about an axis A6. The stabilizing assembly 38 can include a central knuckle 45 coupled with the central portion 40. The central knuckle 45 can include a pin (not shown) that is rotatably supported by a bushing (not shown) of the housing support 21. in such an arrangement, the stabilizing assembly 38 and the rear axle 29 can pivot together about the axis A6. In another embodiment, the stabilizing assembly 38 can be fixedly coupled (e.g., through welding or as an integral one-piece arrangement) with the housing support 21 such that the rear axle 29, the stabilizing assembly 38, and the housing support 21 can move together with respect to the frame 14 of the vehicle 10.

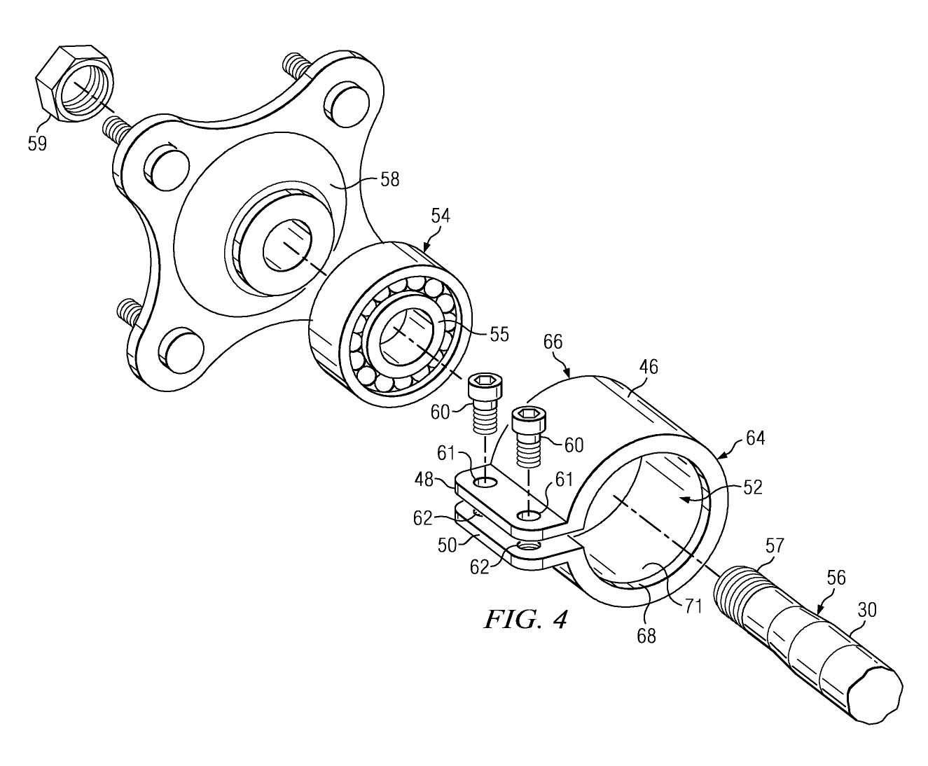

In one embodiment, as illustrated in FIG. 4, the left clamping support 42 can include a split cuff 46 and upper and lower clamping flanges 48, 50 that extend away from the split cuff 46. The split cuff 46 can define a passageway 52 and a left bearing 54 can he disposed within the passageway 52. An inner race 55 of the left bearing 54 can support the left shaft 30 to journal the left shaft 30 with respect to the left clamping support 42. The left shaft 30 can include a tapered portion 56. When the left shaft 30 is provided through the inner race 55 of the left bearing 54, the inner race 55 can slide over the tapered portion 56 and into a press fit arrangement with the left shaft 30 to couple the left bearing 54 to the left shaft 30 (e.g., as shown in FIG. 6). The left shaft 30 can include a threaded end 57. The threaded end 57 can be provided through a left huh 58 and a bolt 59 can be threaded onto the threaded end 57 to couple the left hub 58 with the left shaft 30. It will be appreciated that an axle shaft can be coupled with a bearing in any of a variety of suitable alternative arrangements.

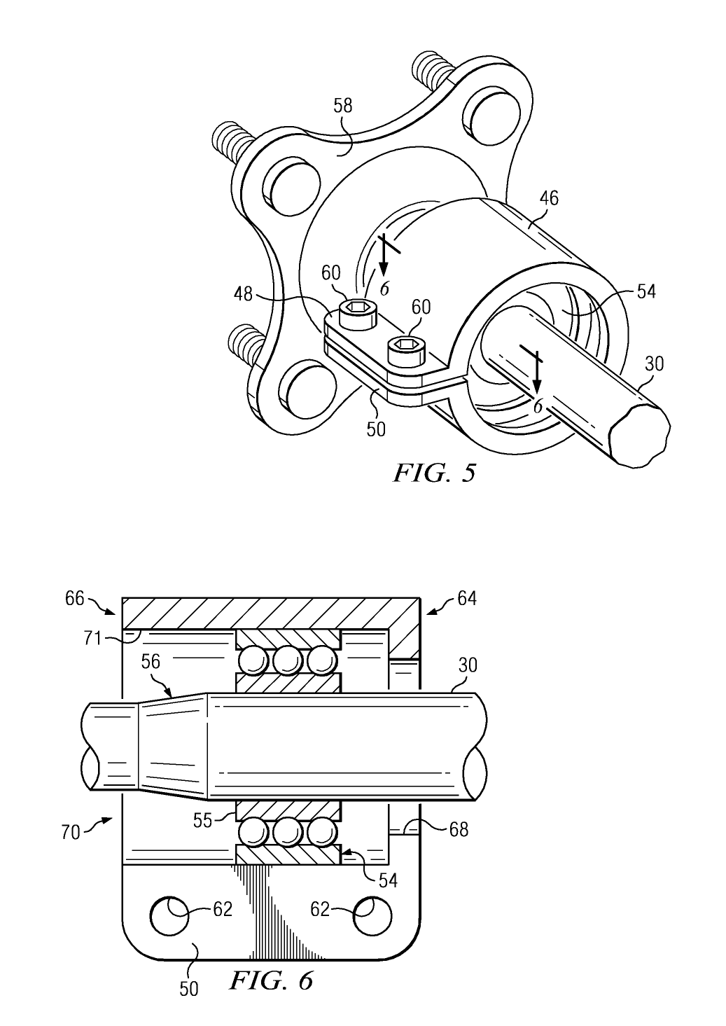

In one embodiment, the upper and lower clamping flanges 48, 50 can be coupled together with bolts 60. As illustrated in FIG. 4, the upper clamping flange 48 can define a pair of non-threaded passageways 61 and the lower clamping flange 50 can define a pair of threaded passageways 62. Each of the bolts 60 can pass through a respective one of the non-threaded passageways 61 and into threaded engagement with a respective one of the aligned threaded passageways 62. The upper and lower flanges 48, 50 can be biased apart from each other such that threading the bolts 60 into the respective threaded passageways 62 pulls the upper and lower flanges 48, 50 together. The left bearing 54 can thus he selectively clamped within the passageway 52 with the bolts 60. For example, when the upper and lower clamping flanges 48, 50 are biased apart from each other (e.g.. the left clamping support 42 is in an unclamped position as illustrated in FIG. 4), the inside diameter of the split cuff 46 can be greater than the outside diameter of the left bearing 54 such that the left bearing 54 can be installed into the passageway 52. As the bolts 60 arc threaded into the threaded passageways 62 (e.g., tightened) the inner diameter of the split cuff 46 can decrease until the left bearing 54 is clamped within the passageway 52 by the split cuff 46 (e.g., the left clamping support 42 is in a clamped position as illustrated in FIG. 5).

It will be appreciated that the left bearing 54 can be installed into and/or removed from the left clamping support 42 without requiring press fitting of the left bearing 54 into/out of the left clamping support 42 which can be time consuming and can sometimes result in damage to the left bearing 54. It will also be appreciated that the left bearing 54 can be installed within the left clamping support 42 without the use of shims as might be required with some conventional axle assembly arrangements.

In one embodiment, the split cuff 46 can he configured to facilitate one-way installation/removal of the left bearing 54. As illustrated in FIGS. 4-6, the left clamping support 42 can extend between a proximal end 64 and a distal end 66. The proximal end 64 of the split cuff 46 can define an annular shoulder 68 (FIGS. 4-6) and the distal end 66 of the split cuff 46 can define an opening 70 (FIG. 6). The opening 70 can be sized to permit passage of the left bearing through the opening 70 (e.g., when the upper and lower flanges 48, 50 are biased apart). The inner diameter of the annular shoulder 68, however, can he less than outer diameter of the left bearing 54 and can thus prevent passage of the left bearing 54 through the proximal end 64 of the left clamping support 42.

A bearing support surface 71 can extend from the opening 70 to the annular shoulder 68. In one embodiment, the bearing support surface 71 can comprise a substantially cylindrical surface that extends from the opening 70 of the split cuff 46 to the annular shoulder 68. When the left clamping support 42 is in the undamped position, the left bearing 42 is free to move within the passageway 52. The left bearing 54 can thus be selectively positioned between the opening 70 of the split cull 46 to the annular shoulder 68 prior to being clamped within the passageway 52.

It will be appreciated that the clamping force applied to the left bearing 54 can be controlled with the bolts 60. For example, tightening the bolts 60 can increase the clamping force applied to the left bearing 54 and loosening the bolts 60 can reduce the clamping force applied to the left bearing 54. In addition, tightening one of the bolts 60 more than the other bolt 60 can apply more clamping force to one side of the left bearing 54 than the other. The clamping three can therefore be adjusted to control the amount of axial force transmitted through the left bearing 50 to the stabilizing assembly 38: It will also he appreciated that, the bolts 60 can he adjusted to reduce the clamping force enough to free the left bearing 54 from the left clamping support 42 (e.g., the left clamping support 42 in the unclamped position) without fully removing the bolts 60 as shown FIG. 4.

The right clamping support 44 can he similar in many respects to the left clamping support 42 but provided at a right side of the vehicle 10 for support of a right bearing 72 (shown in FIG. 2). For example, the right bearing 72 can journal the right shaft 31 of the rear axle 29 with respect to the right clamping support 44. The right clamping support 44 can include a split cuff 74 having upper and lower clamping flanges 76, 78, as illustrated in FIG. 2. The upper and lower clamping flanges of the right clamping support 44 can be coupled together with bolts 80 (FIG. 3) to facilitate selective clamping of the right bearing 72 by the right clamping support 44.

It will be appreciated that the distance between the left and right bearings 54, 72 (e.g., d1 shown in FIG. 3) can be selectively varied. The left and right bearings 54, 72 can accordingly be positioned within the respective split cuffs 46, 74 to account for manufacturing tolerances of the stabilizing assembly 38 and/or to achieve certain performance of the rear axle 29. It will be appreciated that, although the axle assembly 11 is described with respect to the rear axle 29, an axle assembly can be additionally or alternatively provided for other axles of a vehicle, such as a front axle, for example.

The foregoing description of embodiments and examples has been presented for purposes of illustration and description. It is not intended to be exhaustive or limiting to the forms described. Numerous modifications are possible in light of the above teachings. Some of those modifications have been discussed and others will be understood by those skilled in the art. The embodiments were chosen and described for illustration of various embodiments. The scope is, of course, not limited to the examples or embodiments set forth herein, but can be employed in any number of applications and equivalent devices by those of ordinary skill in the art. Rather it is hereby intended the scope be defined by the claims appended hereto.

What is claimed is:

1. A vehicular axle assembly comprising:
a swing member configured for pivotal attachment to a frame of a vehicle;
a housing support coupled with the swing member;
an axle rotatably coupled with the housing support and rotatable about a first axis;
a stabilizing assembly coupled with the housing support and comprising a left clamping support and a right clamping support, the left clamping support defining a left passageway and the right clamping support defining a right passageway;
a left bearing at least partially disposed within the left passageway and clamped within the left passageway by the left clamping support; and
a right bearing at least partially disposed within the right passageway and clamped within the right passageway by the right clamping support;
wherein the left bearing and the right bearing journal the axle with respect to the left and right clamping supports, respectively.

2. The vehicular axle assembly of claim 1 wherein the stabilizing assembly is pivotally coupled with the housing support such that the stabilizing assembly and the axle are pivotal about a second axis.

3. The vehicular axle assembly of claim 1 further comprising a housing rotatably supported by the housing support and coupled with the axle.

4. The vehicular axle assembly of claim 1 wherein the axle comprises a single, continuous shaft.

5. The vehicular axle assembly of claim 1 wherein the left clamping support comprises a left split cuff and the right clamping support comprises a right split cuff.

6. The vehicular axle assembly of claim 5 wherein the tell split cuff comprises a left annular shoulder and the left split cuff defines a left bearing support surface adjacent to the left annular shoulder, and wherein the right split cuff comprises a right annular shoulder and the right split cuff defines a right bearing surface adjacent to the right annular shoulder.

7. The vehicular axle assembly of claim 1 wherein the left clamping support further comprises a pair of left clamping flanges and the right clamping support further comprises a pair of right clamping flanges.

8. The vehicular axle assembly of claim 7 further comprising a first bolt and a second bolt, wherein the left clamping flanges are coupled together with the first bolt and the right clamping flanges are coupled together with the second bolt.

9. The vehicular axle assembly of claim 8, wherein one of the left clamping flanges defines a non-threaded aperture for receiving the first bolt and one of the right clamping flanges defines a non-threaded aperture fir receiving the second bolt.

10. A vehicle comprising:
a frame;
a swing member attached to the frame;
a housing support coupled with the swing member;
an axle rotatably coupled with the housing support and rotatable about a first axis;
a stabilizing assembly coupled with the housing support and comprising a left clamping support and a right clamping support, the left clamping support defining a left passageway and the right clamping support defining a right passageway;
a left bearing at least partially disposed within the left passageway and clamped within the left passageway by the left clamping support; and
a right bearing at least partially disposed within the right passageway and clamped within the right passageway by the right clamping support;
wherein the left bearing and the right bearing journal the axle with respect to the left and right clamping supports, respectively.

11. The vehicle of claim 10 wherein the stabilizing assembly is pivotally coupled with the housing support such that the stabilizing assembly and the axle are pivotal about a second axis.

12. The vehicle of claim 10 further comprising a housing rotatably supported by the housing support and coupled with the axle, the housing being rotatable about a housing axis.

13. The vehicle of claim 10 wherein the axle comprises a single, continuous shaft.

14. The vehicle of claim 10 wherein the left clamping support and the right clamping support each comprise an interior annular shoulder.

15. The vehicle of claim 10 wherein the left clamping support further comprises a pair of left clamping flanges and the right clamping support further comprises a pair of right clamping flanges.

16. The vehicle of claim 13 wherein the left clamping flanges are releasably coupled together with a first pair of bolts and the right clamping flanges are releasably coupled together with a second pair of bolts.

17. The vehicle of claim 13 wherein the left flanges are biased apart from each other and the right flanges arc biased apart from each other.

18. A vehicle comprising:
a frame;
a swing member attached to the frame;
a housing support coupled with the swing member;
an axle rotatably coupled with the housing support and rotatable about a first axis;
a stabilizing assembly coupled with the housing support and comprising:
a central portion coupled with the housing support;
a left clamping support coupled with central portion and comprising a left split cuff, a left upper clamping flange, and a left lower clamping flange, the left split cuff defining a left passageway, the left upper clamping flange defining a non-threaded passageway, and the left lower clamping flange defining a threaded passageway; and
a right clamping support coupled with central portion and comprising a right split cuff, a right upper clamping flange, and a right lower clamping flange, the right split cuff
defining a right passageway, the right upper clamping flange defining a non-threaded passageway, and the right lower clamping flange defining a threaded passageway;
a left bearing at least partially disposed within the left passageway;
a first bolt extending through the non-threaded passageway of the left upper clamping flange and into the threaded passageway of the left lower clamping flange;
a right bearing at least partially disposed within the right passageway; and
a second bolt extending through the non-threaded passageway of the right upper clamping flange and into the threaded passageway of the right lower clamping flange;
wherein the left bearing and the right bearing journal the axle with respect to the left and right clamping supports, respectively.

19. The vehicle of claim 18 wherein the central portion is pivotally coupled with the housing support and pivotable with respect to the housing about a second axis.
